(19) United States
(12) Patent Application Publication
(10) Pub. No.: US 2026/0178190 A1
(43) Pub. Date: Jun. 25, 2026

(54) SYSTEMS, APPARATUSES, METHODS, AND NON-TRANSITORY COMPUTER-READABLE STORAGE MEDIA FOR FACILITATING USER INTERACTION WITH A VIRTUAL KEYBOARD

(71) Applicant: HUAWEI TECHNOLOGIES CO., LTD., Shenzhen (CN)

(72) Inventors: Yuan Deng, Markham (CA); Qijia Peng, Shanghai (CN); Wei Li, Richmond Hill (CA); Shuping Lu, Richmond Hill (CA); Yixuan Wang, Shenzhen (CN); Xueyan Huang, Shenzhen (CN); Jun Hu, Dongguan (CN)

(21) Appl. No.: 18/987,052

(22) Filed: Dec. 19, 2024

(51) Int. Cl. G06F 3/04895; G06F 3/04886

(52) U.S. Cl. CPC G06F 3/04895; G06F 3/04886

(57) ABSTRACT

Systems, apparatuses, methods, and computer-readable storage media are disclosed for facilitating user interaction with a virtual keyboard. A computerized method comprises: receiving contextual information associated with a virtual keyboard displayed on a user interface; determining, based on the contextual information, that a visual hint display condition is met; displaying a visual hint associated with one or more keys of the virtual keyboard based on the visual hint display condition; after displaying the visual hint, receiving additional contextual information associated with the virtual keyboard; determining, based on the additional contextual information, that a visual hint dismissal condition is met; and dismissing the visual hint from the virtual keyboard based on the visual hint dismissal condition.

### FIELD OF THE DISCLOSURE

The present disclosure relates generally to systems, apparatuses, methods, and non-transitory computer-readable storage media for facilitating user interaction with a virtual keyboard, and in particular to systems, apparatuses, methods, and non-transitory computer-readable storage media for presenting visual guidance to users when typing on a virtual keyboard.

### BACKGROUND

Typing on a virtual keyboard presents several challenges that significantly impact efficiency compared to a physical keyboard. Unlike physical keyboards, which support touch typing through strategies such as anchoring fingers on the F and J keys, virtual keyboards lack these tactile cues, making touch typing impractical. This results in a substantial increase in the time spent monitoring fingers, with non-touch typing typically requiring at least 40% of the time to look at the keyboard, compared to 20% for touch typing.

The need to frequently check or look at the keyboard often reduces typing speed. Moreover, when it comes to using dual touch screens or a foldable PC device (e.g. a laptop setup), the virtual keyboard is typically positioned beyond the optimal vision range (more than 15 degrees below eye level), requiring eye and head rotation that can contribute to eye and neck fatigue. Overall, the increased visual strain and physical discomfort further exacerbate the difficulties of typing on a virtual keyboard.

Furthermore, users are expecting some features that would not only help users effectively adapt to a virtual keyboard but also bring a unique and/or improved typing experience. Accordingly, a virtual keyboard should not simply be a soft copy of physical keyboard, but rather should facilitate and support user interaction with the virtual keyboard.

Accordingly, systems, apparatuses, methods, and computer-readable storage media for facilitating user interaction with a virtual keyboard remain highly desirable.

### SUMMARY

According to one aspect of this disclosure, there is provided a computerized method, comprising: receiving contextual information associated with a virtual keyboard displayed on a user interface; determining, based on the contextual information, that a visual hint display condition is met; displaying a visual hint associated with one or more keys of the virtual keyboard based on the visual hint display condition; after displaying the visual hint, receiving additional contextual information associated with the virtual keyboard; determining, based on the additional contextual information, that a visual hint dismissal condition is met; and dismissing the visual hint from the virtual keyboard based on the visual hint dismissal condition.

In some embodiments, determining that the visual hint dismissal condition is met comprises determining that the visual hint display condition is no longer met, and dismissing the visual hint from the virtual keyboard when the visual hint display condition is no longer met.

In some embodiments, the visual hint dismissal condition is based on the visual hint display condition.

In some embodiments, the contextual information comprises one or more of: a user's finger and/or palm position with respect to the virtual keyboard, one or more keys pressed by the user on the virtual keyboard, word and/or sentence context written by the user of the virtual keyboard, writing suggestions, and input-method generated character/symbol candidate suggestions.

In some embodiments, the visual hint display condition is one of: one or both user palms are resting in a region below the virtual keyboard in a pre-typing state for a first threshold period of time; one or more user fingers are hovering less than a threshold distance above the virtual keyboard for a second threshold period of time; the virtual keyboard is in an idle state for a third threshold period of time; one or more user fingers are hovering less than the threshold distance above an anchoring key area of the virtual keyboard for a fourth threshold period of time; and two or more user fingers are resting on the virtual keyboard for a fifth threshold period of time.

In some embodiments, the visual hint that is displayed is associated with anchoring keys on the virtual keyboard.

In some embodiments, the visual hint dismissal condition is that a user has pressed any key on the virtual keyboard.

In some embodiments, the visual hint display condition is a spelling error.

In some embodiments, the visual hint that is displayed is associated with one or more keys for correcting the spelling error, and the visual hint dismissal condition is that a user has pressed the one or more keys associated with the visual hint.

In some embodiments, the visual hint display condition is a predicted punctuation.

In some embodiments, the visual hint that is displayed is associated with one or more keys for the predicted punctuation, and the visual hint dismissal condition is that a user has pressed the one or more keys associated with the predicted punctuation.

In some embodiments, the visual hint display condition is one of: a writing suggestion provided by an application; and a writing suggestion provided by the virtual keyboard.

In some embodiments, the visual hint that is displayed is associated with one or more keys for implementing the writing suggestion.

In some embodiments, the visual hint dismissal condition is that the writing suggestion has been implemented.

In some embodiments, the visual hint display condition is one or more user fingers hovering less than a threshold distance over a key on the virtual keyboard corresponding to an input-method generated character/symbol suggestion for a threshold period of time.

In some embodiments, the visual hint that is displayed is associated with the key that the one or more user finger is hovering over, and/or the input-method generated character/symbol suggestion corresponding to the key.

In some embodiments, the visual hint dismissal condition is that the user has chosen the suggested symbol by pressing the corresponding key on the virtual keyboard.

In some embodiments, displaying the visual hint associated with the one or more keys of the virtual keyboard comprises highlighting the one or more keys of the virtual keyboard.

In some embodiments, displaying the visual hint associated with the one or more keys comprises dynamically displaying the visual hint.

In some embodiments, displaying the visual hint associated with the one or more keys of the virtual keyboard comprises highlighting a selection on the user interface that corresponds to the one or more keys of the virtual keyboard.

According to one aspect of this disclosure, there is provided one or more processors functionally connected to one or more memories storing instructions, the one or more processors are configured to execute the instructions to perform the above-described method.

According to one aspect of this disclosure, there is provided an apparatus comprising one or more processors functionally connected to one or more memories storing instructions; the one or more processors are configured to execute the instructions to perform the above-described method.

According to one aspect of this disclosure, there is provided one or more memories storing instructions; the instructions, when executed, cause one or more processors to perform the above-described method.

In another aspect, embodiments of this disclosure provide an apparatus, wherein the apparatus comprises a function or unit to perform any of the methods disclosed herein.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configured to perform any of the methods disclosed herein.

According to one aspect of this disclosure, there is provided a module comprising: one or more circuits for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus configured to perform the above-described method.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform the above-described method.

According to one aspect of this disclosure, there is provided one or more computer-readable storage media storing a computer program, wherein, when the computer program is executed by an apparatus, the apparatus is enabled to implement the above-described method.

According to one aspect of this disclosure, there is provided a computer program product including one or more instructions, wherein, when the instructions are executed by an apparatus, the apparatus is enabled to implement the above-described method.

According to one aspect of this disclosure, there is provided a computer program, wherein, when the computer program is executed by a computer, an apparatus is enabled to implement the above-described method.

According to one aspect of this disclosure, there is provided a system comprising a node for performing the above-described method.

According to one aspect of this disclosure, there is provided an apparatus for implementing the method in any possible implementation of the foregoing aspects.

In various embodiments, the systems, apparatuses, methods, and computer-readable storage media disclosed herein provide several advantages and benefits.

For example, the systems, apparatuses, methods, and computer-readable storage media disclosed herein provide a comprehensive solution for displaying visual guidance/hints on a virtual keyboard and/or on a user interface when it is most necessary. The systems, apparatuses, methods, and computer-readable storage media disclosed herein address several problems, including but not limited to: 1) when and what contextual information to detect to determine when to display a visual hint; 2) where and how to present the visual hints, including whether they should be generated by prediction or by preset rules; and 3) how to dismiss the visual hints when they are no longer needed. By evaluating more contextual information associated with the visual keyboard, more types of visual hint display conditions can be detected and thus identify the most appropriate timing for presenting a visual hint. In some embodiments, the contextual information may comprise one or more of: a user's finger and/or palm position with respect to the virtual keyboard, one or more keys pressed by the user on the virtual keyboard, word and/or sentence context written by the user of the virtual keyboard, writing suggestions (including text, words, phrases, numbers, punctuation, symbols, emojis, etc.), and input-method generated character/symbol candidate suggestions. Being able to accurately identify more visual hint display conditions allows to present visual hints when users may find it most desirable to focus on the virtual keyboard, thus aligning more closely with user expectations.

The systems, apparatuses, methods, and computer-readable storage media disclosed herein can address the most critical scenarios where users need to focus on the keyboard, presenting visual hints in situations that more closely aligning with user expectations. In some embodiments, the visual guidance is present to help users more quickly adjust their hand posture before typing, more quickly identify correct keystrokes after making errors, quickly pick an input-method generated character/symbol candidate when typing in Chinese characters, etc.

In some embodiments, visual hints are displayed in association with anchoring keys (e.g. the F and J keys) on the virtual keyboard before starting the typing, allowing users to quickly adjust the hand postures before typing In some embodiments, visual hints are displayed in association with one or more predicted correct letters, punctuation keys, and/or applicable function keys, allowing users to quickly identify correct keystrokes after making errors or to quickly type the correct punctuation key In some embodiments, visual hints are displayed in association with one or more predicted keys for interacting with writing tools generated by an editor application, allowing users to quickly identify the correct keys and interact with the writing tools to select suggested word/texts.

In some embodiments, when an editor application does not have its own writing suggestion mechanism, the virtual keyboard system can provide the writing suggestions for completion and/or correction and present the hints onto the editor interface, thus extending the keyboard's writing assistant capability to more applicable editor applications.

In some embodiments, the visual hints are displayed in association with an input-method generated character/symbol candidate suggestions corresponding to a key (e.g. a number key) of the virtual keyboard. For example, in a Chinese character input method, the visual hint may be displayed to highlight the corresponding candidate on an editor interface or other graphical user interface (GUI), such as in-line or in a floating window, and/or on the corresponding key of the keyboard, allowing users to quickly pick a character/symbol candidate when typing in Chinese pinyin without even checking the keyboard.

Furthermore, by evaluating additional contextual information after displaying the visual hint, the systems, apparatuses, methods, and computer-readable storage media disclosed herein can determine whether a visual hint dismissal condition is met and dismiss the visual hint from the virtual keyboard. Accordingly, visual hints are shown only when it is necessary rather than being shown and refreshed constantly. The systems, apparatuses, methods, and computer-readable storage media disclosed herein thus help to reduce redundant computing and power consumption of a virtual keyboard.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM);

FIG. 5 is a computerized method for facilitating user interactions with a virtual keyboard;

FIG. 6 is a method for facilitating user interactions with the virtual keyboard according to a first aspect of a first embodiment;

FIGS. 7A and 7B are representations of the user interactions with the virtual keyboard according to the first aspect of the first embodiment;

FIG. 8 is a method for facilitating user interactions with the virtual keyboard according to a second aspect of the first embodiment;

FIG. 9 is a representation of the user interactions with the virtual keyboard according to the second aspect of the first embodiment;

FIGS. 10A and 10B are methods for facilitating user interactions with the virtual keyboard according to a third and fourth aspect of the first embodiment, respectively;

FIGS. 11A and 11B are representations of the user interactions with the virtual keyboard according to the third and fourth aspects of the first embodiment, respectively;

FIG. 12 is a method for facilitating user interactions with the virtual keyboard according to a first aspect of a second embodiment;

FIGS. 13A and 13B are representations of the user interactions with the virtual keyboard according to the first aspect of the second embodiment;

FIG. 14 is a method for facilitating user interactions with the virtual keyboard according to a second aspect of the second embodiment;

FIG. 15 is a representation of the user interactions with the virtual keyboard according to the second aspect of the second embodiment;

FIG. 16 is a method for facilitating user interactions with the virtual keyboard according to an aspect of a third embodiment;

FIG. 17 is a representation of the user interactions with the virtual keyboard according to the aspect of the third embodiment;

FIG. 18 is a method for facilitating user interactions with the virtual keyboard according to an aspect of a fourth embodiment;

FIGS. 19A and 19B are representations of the user interactions with the virtual keyboard according to the aspect of the fourth embodiment;

FIG. 20 is a method for facilitating user interactions with the virtual keyboard according to an aspect of a fifth embodiment; and

FIG. 21 is a representation of the user interactions with the virtual keyboard according to the aspect of the fifth embodiment.

### DETAILED DESCRIPTION

The role of visual guidance is important when using virtual keyboards to assist users with maintaining correct hand positions, avoiding drifting, and locating letters, particularly after errors. Existing solutions to facilitate typing on the virtual keyboard provide visual hints, such as by employing language models or input gestures to continuously predict word or letter probabilities and highlighting these predictions through user interfaces (UIs).

However, existing solutions for providing visual hints have notable limitations. For example, on a larger screen setup, such as a clamshell/laptop setup, users prefer to minimize keyboard checks as frequent keyboard checking requires eye and/or head rotation and can easily cause eye and neck fatigue. Moreover, the constant display of visual hints often becomes redundant, and less effective, in addition to increasing the amount of computing resources and power consumption.

Additionally, the generation of visual hints in existing solutions frequently overlooks important scenarios where visual hints may be particularly useful, such as correcting errors, interacting with writing tools, or selecting Chinese (or other language) symbols/characters. Furthermore, the contextual information utilized in existing solutions is often limited, reducing the overall effectiveness of these visual aids.

Embodiments disclosed herein describe systems, apparatuses, methods, and computer-readable storage media that provide a comprehensive solution for displaying visual hints on a virtual keyboard and/or on a user interface when it is most necessary, and subsequently dismissing the visual hint when it is no longer needed. A computerized method comprises: receiving contextual information associated with a virtual keyboard displayed on a user interface; determining, based on the contextual information, that a visual hint display condition is met; displaying a visual hint associated with one or more keys of the virtual keyboard based on the visual hint display condition; after displaying the visual hint, receiving additional contextual information associated with the virtual keyboard; determining, based on the additional contextual information, that a visual hint dismissal condition is met; and dismissing the visual hint from the virtual keyboard based on the visual hint dismissal condition.

The embodiments disclosed herein can thus address several scenarios where users need to focus on the keyboard, providing improved visual guidance that is displayed when users need it most. Particular embodiments disclosed herein describe specific scenarios for displaying visual guidance, and include but are not limited to:
(1) based on detecting finger-hovering/resting and/or palm resting, or using a time-based strategy, presenting visual hints on a virtual keyboard for users to adjust hand postures before typing;
(2) based on input context, language-model analysis, and/or prediction, presenting visual hints on a virtual keyboard for users to correct typing errors and/or add punctuation;
(3) based on communication between the virtual keyboard and an editor application, presenting visual hints on the virtual keyboard for a user to interact with writing suggestion tools;
(4) based on input context and language-model or AI model analysis, presenting visual hints on one or both of the virtual keyboard and an editor application interface for word/sentence/punctuation prediction or correction;
(5) based on detecting finger-hovering, presenting visual hints on one or both of a virtual keyboard and a language input method user interface (e.g. Chinese input method) for choosing an input-method generated character/symbol candidate suggestion, which may be selected by choosing a number on a number row of the virtual keyboard.

It will be appreciated that one or more of these embodiments may be combined. That is, one or more of these embodiments may be implemented on a virtual keyboard for facilitating user interactions with the virtual keyboard.

The visual guidance that is displayed may be various types of visual hints that help users to interact with the virtual keyboard. For example, in some embodiments the visual hint may be a static hint that comprises highlighting one or more keys of the virtual keyboard and/or a highlighting a selection on a user interface (e.g. an editor application interface, an input-method interface, etc.) corresponding to the one or more keys of the virtual keyboard. In some embodiments, the visual hint may be any animated/dynamic effect associated with one or more keys. Displaying a visual hint in association with one or more keys may include a visual guidance (e.g. highlighting) that is on the key, behind, the key, and/or surrounding the key. For example, a visual hint could include a hand shape, such as an outline or shadow of a hand, that covers multiple keys.

The systems, apparatuses, methods, and computer-readable storage media for facilitating interactions with a virtual keyboard can be used for any type of virtual keyboard that allows a user to interact therewith, and can include virtual keyboards presented on a touchscreen of user devices, including but not limited to smart phones, laptops, personal computers, etc., including where the virtual keyboard is separate from a main device, such as detachable two touch screen devices (e.g. a personal computer that has duo touch screens or a foldable touch screen formfactor, and can be used in a clamshell state for a laptop-like experience). Particular benefits may be realized by users of laptops or personal computers, where the keyboard is beyond the user's optimal vision range. For a personal computer that has dual touch screens or a foldable touch screen formfactor, and can be used in a clamshell state for a laptop-like experience, in this setup, a virtual keyboard is used as an input application, which is presented on the bottom screen, and the upper screen is used to present the editor application. Utilizing the systems, apparatuses, methods, and computer-readable storage media disclosed herein, a user can type on the virtual keyboard without constantly looking at the keyboard or their fingers, thus avoiding neck and eye fatigue. Additionally, the present disclosure can be applied to virtual keyboards in an augmented reality and/or virtual reality environment.

The systems and apparatuses disclosed herein comprise suitable modules and/or circuitries for executing various procedures. As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system.

Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

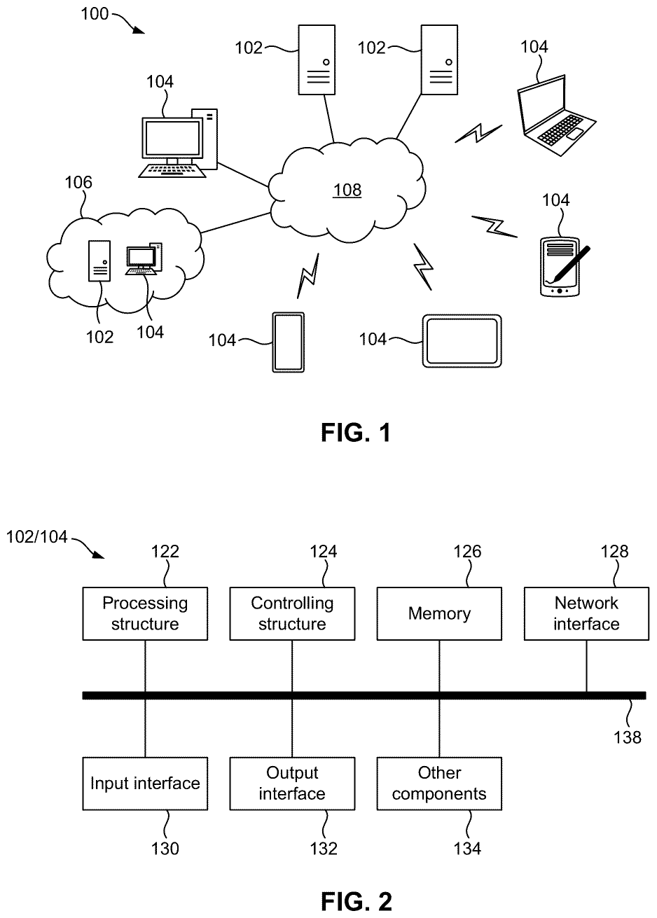

Turning now to FIG. 1, a computer network system is shown and is generally identified using reference numeral 100. As shown, the computer network system 100 comprises one or more server computers 102, a plurality of user devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The user devices 104 may be portable and/or non-portable computing devices such as a tablet, touch screen, personal computer, smart phone, smart watch, smart glasses, a hybrid device, an augmented or virtual reality device, and/or the like. Each user device 104 may execute one or more client application programs which sometimes may be called “apps”. Each user device 104 may allow for web browsing over the network 108. The user devices 104 support user interaction, for example via one or more input devices such as a mouse, touchpad, touchscreen, digital stylus (pen), and/or user voice input, etc. The client computing devices 104 should also equip necessary sensors, computing units, and input/output units, such as CPU, storage disk, memory, Bluetooth, Wi-Fi, IMU sensors, pressure sensors on the screen or on the edge, microphone(s), camera(s), compacity-enable area (for touch-related interaction), display(s), vibration actuator(s), speaker(s), light(s), and button(s).

In accordance with the present disclosure, the user devices 104 in particular support user interaction via a virtual keyboard. The user devices 104 include various hardware components to support user interaction via the virtual keyboard, including but not limited to a touchscreen display, a processor, a memory, and input/output components. The touchscreen display is the primary input device that registers user touches and gestures. The touchscreen display typically includes a capacitive layer that detects touch inputs. The processor may be a central processing unit (CPU) or a dedicated microcontroller that handles the virtual keyboard's software logic, including input processing and customization features. The memory provides a storage for the keyboard's firmware, customization settings, and additional resources like sound files and animations. The input/output components may include microphone(s) that can receive the voice/sound inputs; speaker(s) that can output any kind of sound effects; vibration motor(s) that can provide tactile feedbacks through vibration; stylus that can serve as an input/interaction device, etc.

Generally, the computing devices 102 and 104 comprise similar hardware structures such as hardware structure shown in FIG. 2. As shown in FIG. 2, the computing device hardware structure comprises a processing structure 122, a controlling structure 124, one or more non-transitory computer-readable memory or storage devices 126, a network interface 128, an input interface 130, and an output interface 132, functionally interconnected by a system bus 138. The computing device may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI© (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 of computing devices 102/104 comprises one or more input modules for one or more users to input data via, for example, touch-sensitive screen, touch-sensitive whiteboard, touch-pad, keyboards, computer mouse, trackball, microphone, scanners, cameras, buttons, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementations, may be integrated with a display output to form a touch-sensitive screen or touch-sensitive whiteboard. The output interface 132 comprises one or more output modules for output data to a user.

Examples of the output modules comprise displays (such as monitors, LCD displays, LED displays, projectors, and the like), speakers, printers, lights, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device may also comprise other components 134 such as one or more positioning modules, temperature sensors, pressure sensors, barometers, inertial measurement unit (IMU), and/or the like.

The system bus 138 interconnects various components 122 to 134 enabling them to transmit and receive data and control signals to and from each other.

In accordance with the present disclosure, the user devices 104 also include various software components to support user interaction via the virtual keyboard, including but not limited to: an input handling module, a rendering engine, finger-hover detection algorithms/modules, palm detection algorithms/modules, a language model, Artificial Intelligence (AI) or Large Language Model (LLM) models, and an application programming interface.

The input handling module processes touch inputs from the touchscreen and translates them into key presses. The rendering engine is responsible for drawing the keyboard's visual elements on the screen, including keys, backgrounds, visual hints, and animations. The finger-hover detection algorithms/modules are used to sense a user's finger when it's hovering just above the surface, without actually touching it. For example, one solution for this module is to detect the changes of capacitive signals on the touch screen with versus without finger hover. The palm detection algorithms/modules are used to detect a palm resting on the screen. A language model predicts the next word or character based on the context of what has already been typed. A language model uses patterns and statistical probabilities from a large dataset to enhance text input, improving accuracy and fluency in typing by suggesting completions, correcting mistakes, or offering relevant words. Similar to a language model, AI or LLM models can be used for word and sentence level writing suggestions, including completions, correcting mistakes, or offering relevant words. The AI/LLM models can be either local or cloud-based which can be accessed via network connection. The application program interface is a module that allows the virtual keyboard to either one-directionally or mutually communicate with other software applications, such as with a third party editor and/or a Chinese input method editor (IME).

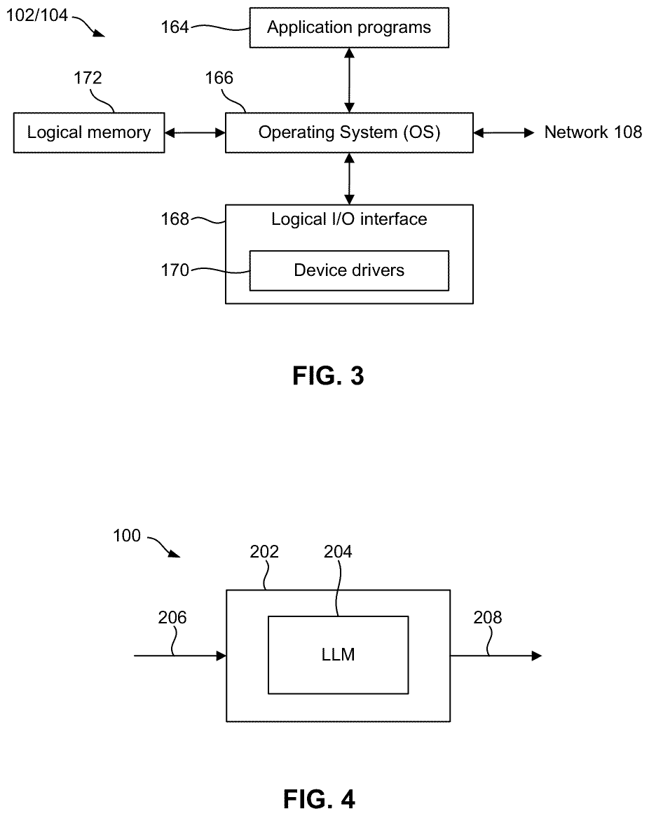

FIG. 3 shows a simplified software architecture of the computing device 102 or 104. On the software side, the computing device comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 are executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with user devices 104 and facilitating collaboration between the server computer 102 and the user devices 104. Herein, the term “server” may refer to a server computer 102 from a hardware point of view or a logical server from a software point of view, depending on the context. Similarly, in a user device 104, the one or more application programs generally provide functionality for users of the user devices 104 and that communicate with the server computer 102.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

In some embodiments, the computer network system 100 executes an artificial intelligence (AI) engine (for example, in the form of one or more software programs). As shown in FIG. 4, the AI engine 202 comprises a language processing model (such as a LLM 204) for processing input 206 (also called “prompt”; for example, natural language input in the form of text, voice, images, and/or the like), recognizing and interpreting the input 206 for generating the output 208 in suitable forms as the response to the prompt 206. As those skilled in the art will appreciate, models such as LLMs are neural network models that learn the semantics and syntax of language by encoding (sub)words into vector representations.

Using LLMs as an example, LLMs use transformer models and are trained using massive datasets. Current LLMs such as Chat-GPT, GPT-4, LLaMA, and PaLM2 have proven to achieve state-of-the-art (SOTA) performance in various natural language processing (NLP) tasks.

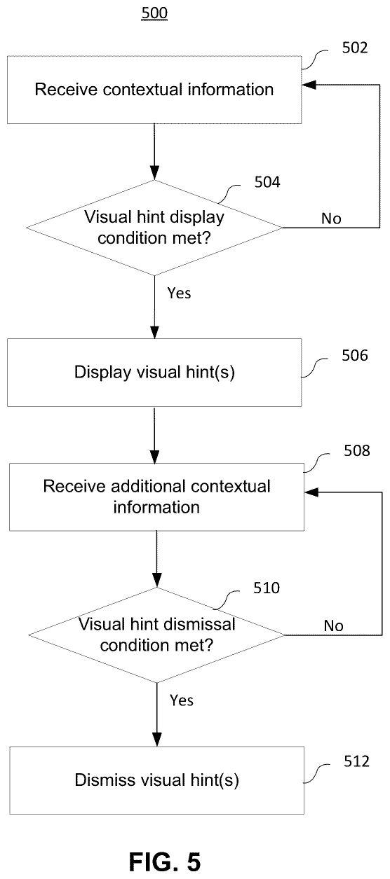

FIG. 5 is a method 500 for facilitating user interactions with a virtual keyboard. The method 500 is a computerized method implemented by a user device that provides a virtual keyboard for a user to interact with. The user device providing the virtual keyboard may also comprise an interface for displaying content and/or applications to a user, or may be communicatively coupled to a separate device that provides the interface for displaying content and/or applications.

The computerized method 500 comprises receiving contextual information associated with a virtual keyboard displayed on a user interface (502). As described in more detail below, the contextual information may for example comprise one or more of: a user's finger and/or palm position with respect to the virtual keyboard, one or more keys pressed by the user on the virtual keyboard, word and/or sentence context written by the user of the virtual keyboard, writing suggestions (including text, words, phrases, numbers, punctuation, symbols, emojis, etc.), and input-method generated character/symbol candidate suggestions.

It is determined, based on the contextual information, whether a visual hint display condition is met (504). If the visual hint display condition is not met (No at 504), the method 500 continues to receive contextual information at 502. If it is determined that the visual hint display condition is met (Yes at 504), a visual hint(s) is displayed in association with one or more keys of the virtual keyboard (506). As described in more detail below, the visual hint(s) that is displayed is based on the visual hint display condition that is satisfied. The visual hint(s) may be displayed as a static or dynamic hint. Displaying the visual hint(s) may comprise highlighting one or more keys of the virtual keyboard. Additionally or alternatively, displaying the visual hint(s) may comprise highlighting a selection on an editor and/or input method interface corresponding to the one or more keys of the virtual keyboard.

After displaying the visual hint(s), the method 500 comprises receiving additional contextual information associated with the virtual keyboard (508). It is determined, based on the additional contextual information, whether a visual hint dismissal condition is met (510). As described in more detail below, the visual hint dismissal condition may be based on the visual hint display condition that was detected. If the visual hint dismissal condition is not met (No at 510), the method 500 continues to receive the additional contextual information at 508. If the visual hint dismissal condition is met (Yes at 510), the visual hint(s) is dismissed from the virtual keyboard.

Additionally, the method 500 may also comprise determining, based on the additional contextual information, whether the visual hint display condition continues to be met. If the visual hint display condition is no longer met, the visual hint may be dismissed from the virtual keyboard. The visual hint dismissal condition may therefore also encompass the condition where the visual hint display condition is no longer met.

Various particular embodiments of visual hint display conditions and the associated visual hint(s) that are presented as well as visual hint dismissal conditions are described below.

A first embodiment of the present disclosure focuses on presenting hint(s) to guide hand postures before a user starts typing. After the user launches the keyboard and stays idle for a certain timeframe (Δt), visual hint(s) may be displayed in association with anchoring keys (e.g. F and J keys) on the virtual keyboard. The visual hint(s) may be displayed in response to detecting a visual hint display condition by detecting palm resting or hand/finger hovering/resting events, or by a time-based strategy. The visual hint(s) may be dismissed after any key is pressed. There are several aspects contemplated in the first embodiment to trigger the visual hint(s).

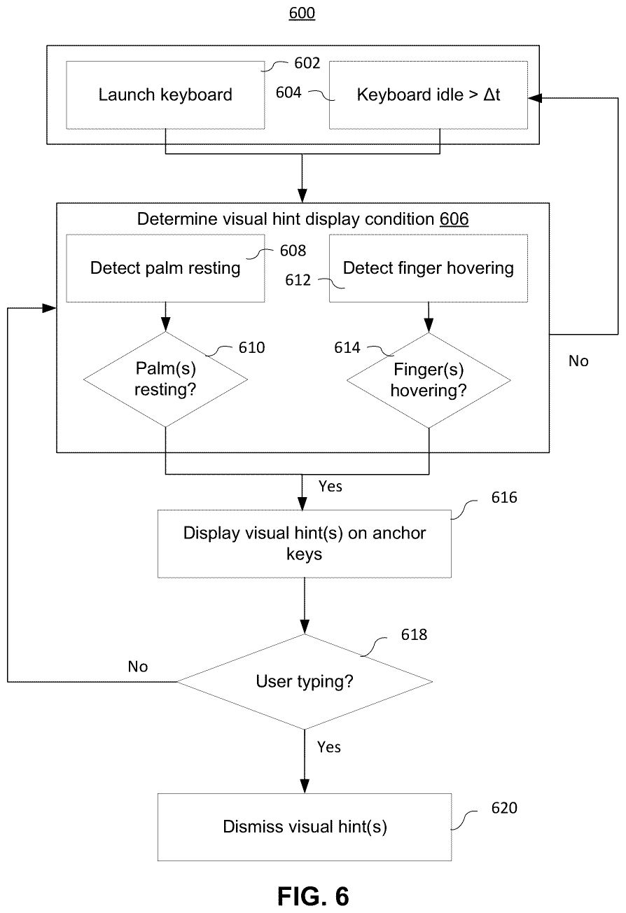

FIG. 6 is a method 600 for facilitating user interactions with the virtual keyboard according to a first aspect of the first embodiment.

A user launches the virtual keyboard (602), and the keyboard is idle for a certain timeframe (604) (no typing event, no palm-resting or finger-hovering event detected and Δt>threshold).

A determination is made if a visual hint display condition is met (606). For a full keyboard layout, which has a region below the virtual keyboard for a user's palm to rest in a pre-typing state, palm resting detection may be performed (608) and a determination is made as to whether one or both user palms are resting in the region below the virtual keyboard for a first threshold period of time (610). Additionally or alternatively, finger hovering detection may be performed (612) and a determination is made as to whether one or more user fingers are hovering less than a threshold distance above the virtual keyboard for a second threshold period of time (614). For a standard keyboard layout (without an area or region below the virtual keyboard to perform palm detection), the system may only perform finger hovering detection.

The determinations made at 610 and 614 are indicative of whether a user is preparing to type. If either determination is true (YES at 610 or 614), the visual hint display condition is satisfied and a visual hint(s) is displayed in association with one or more anchoring keys (e.g. the F and J keys) on the virtual keyboard (616). If the visual hint display condition is not met (NO at 610 and 614), the method 600 returns to detecting the keyboard idle state (604).

After the visual hint(s) is displayed, a determination of whether a visual hint dismissal condition is met is based on whether the user has typed on any key of the virtual keyboard (618), such that the visual hint(s) will be dismissed after the user presses any key. If the user has not started typing (NO at 618), the method 600 continues to determine the visual hint display condition (606). If the user has started typing by pressing any key on the virtual keyboard (YES at 618), the visual hint(s) is dismissed (620).

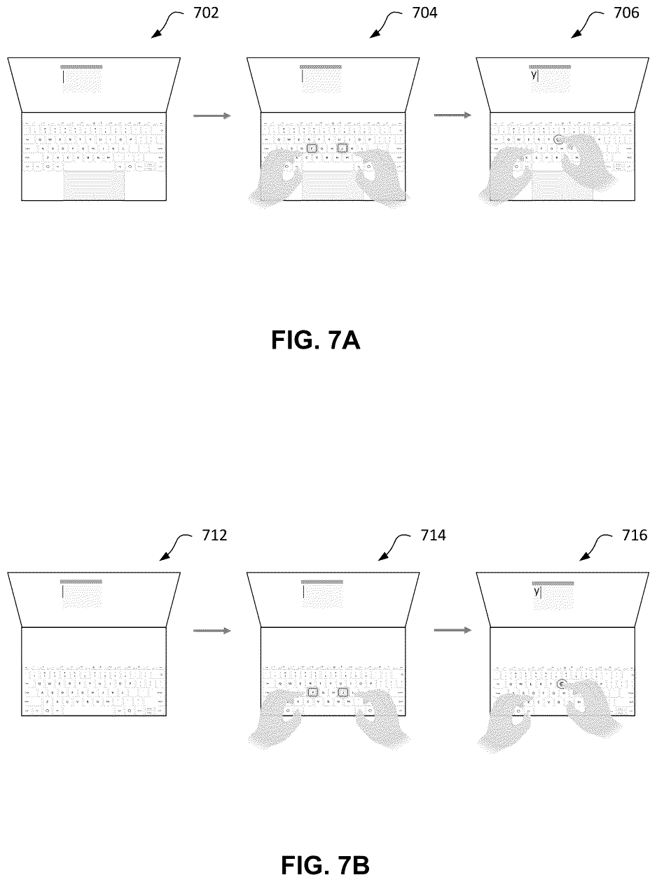

FIGS. 7A and 7B are representations of the user interactions with the virtual keyboard according to the first aspect of the first embodiment. FIG. 7A shows a representation of a full keyboard layout, which has a region below the virtual keyboard to detect a user's palm resting below the virtual keyboard. FIG. 7B shows a representation of a standard keyboard, which comprises the virtual keyboard only and does not have a region below the virtual keyboard to detect a user's palm resting.

As shown in FIGS. 7A and 7B, the virtual keyboard is launched an in an idle state (702, 712). When the visual hint display condition is met, a visual hint is displayed in association with the anchoring (i.e. F and J) keys (704, 714), which is shown as highlighting associated with these keys in this example. When a user has typed any key, the visual hint(s) is dismissed (706, 716).

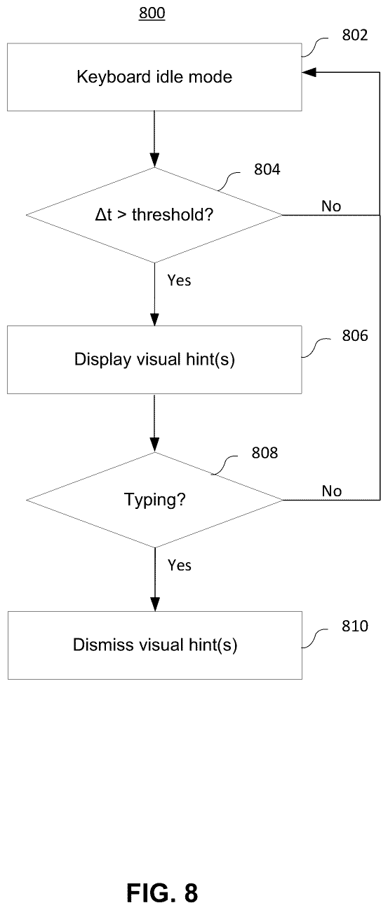

FIG. 8 is a method 800 for facilitating user interactions with the virtual keyboard according to a second aspect of the first embodiment. The second aspect of the first embodiment employs a time-based strategy for displaying visual hint(s) in association with the anchoring keys on the virtual keyboard. In this aspect, a visual hint(s) is triggered after the idle state of keyboard lasts a certain time.

A user launches the virtual keyboard and the keyboard is in an idle mode (802) (i.e. no typing event, no palm-resting or finger-hovering event detected). A visual hint display condition in this aspect is whether the keyboard has been in the idle mode for beyond a threshold period of time. The method 800 comprises determining if the virtual keyboard has been in an idle mode for greater than the threshold (804). If the virtual keyboard has not been in an idle mode for greater than the threshold period of time (NO at 804), the method continues to determine that the keyboard is in the idle mode (802). If the virtual keyboard has been in the idle mode for greater than the threshold period of time (YES at 804), the visual hint display condition is met at and a visual hint(s) is displayed in association with one or more anchoring keys (e.g. the F and J keys) on the virtual keyboard (806).

After the visual hint(s) is displayed, a determination of whether a visual hint dismissal condition is met is based on whether the user has typed on any key of the virtual keyboard (808), such that the visual hint(s) will be dismissed after the user presses any key. If the user has not started typing (NO at 808), the method 800 continues to evaluate that the virtual keyboard is in the idle mode (802). If the user has started typing by pressing any key on the virtual keyboard (YES at 808), the visual hint(s) is dismissed (810).

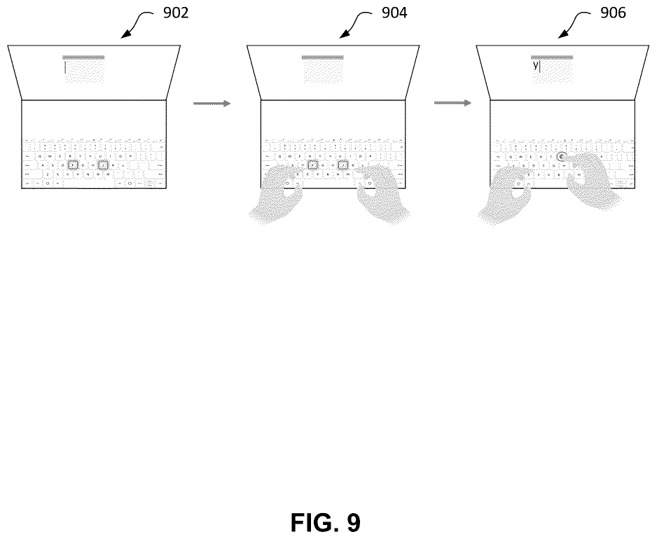

FIG. 9 is a representation of the user interactions with the virtual keyboard according to the second aspect of the first embodiment. As shown in FIG. 9, the virtual keyboard is launched and in an idle mode, and when the virtual keyboard has been in the idle mode for a threshold period of time, a visual hint(s) is displayed in association with the anchoring (i.e. F and J) keys (902), which is shown as highlighting associated with these keys in this example. The user gets ready to type (904), and when the user has typed any key, the visual hint(s) is dismissed (906).

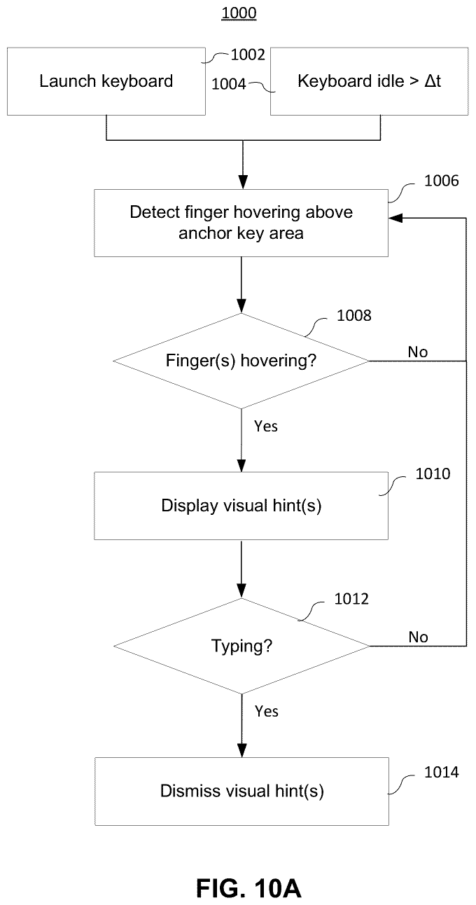

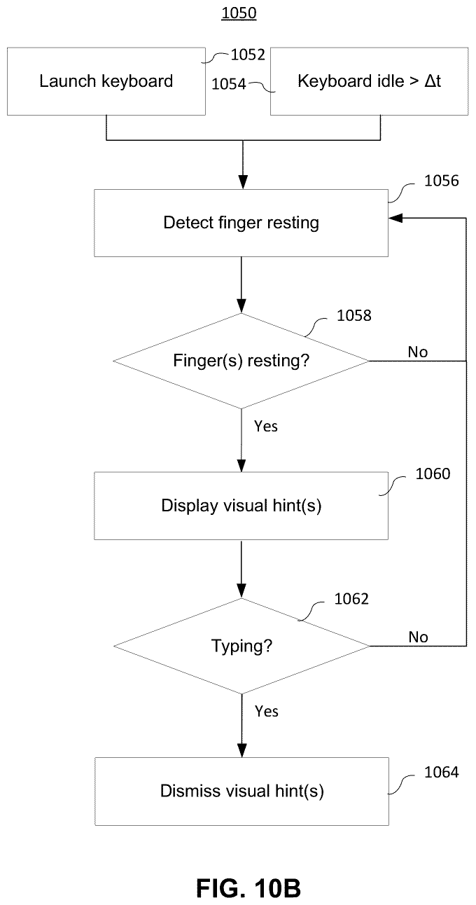

FIG. 10A is a method 1000 for facilitating user interactions with the virtual keyboard according to a third aspect of the first embodiment. In this aspect, a visual hint(s) will be triggered by detecting finger hovering above the anchoring keys (e.g. the F and J keys). The third aspect may be similar to the first aspect in that it detects finger hovering to determine if the visual hint display condition is met, but it is specific to detecting finger hovering above a particular key(s) (in this case, the anchoring keys).

A user launches the virtual keyboard (1002), and the keyboard is idle for a certain timeframe (1004) (no typing event, no palm-resting or finger-hovering event detected and Δt>threshold). A determination is made if a visual hint display condition is met by performing finger hovering detection above the anchor key area (1006). That is, the finger hovering detection comprises determining if one or more user fingers are hovering less than a threshold distance above the anchoring key(s) of the virtual keyboard for a threshold period of time.

If it is determined that the one or more user fingers are hovering above the anchor key area (YES at 1008), the visual hint display condition is satisfied and a visual hint(s) is displayed in association with one or more anchoring keys (e.g. the F and J keys) on the virtual keyboard (1010). If the visual hint display condition is not met (NO at 1008), the method 1000 returns to performing finger hovering detection above the anchor key area (1006). Accordingly, when a user's fingers are far away from the anchoring key (e.g. F and J key) area, no visual hints will be presented, even if the user's fingers are hovering above a different area of the keyboard. Only when the user hovers a finger above the anchoring key(s), visual hint(s) will be presented in association with the anchoring keys.

After the visual hint is displayed, a determination of whether a visual hint dismissal condition is met is based on whether the user has typed on any key of the virtual keyboard (1012), such that the visual hint(s) will be dismissed after the user presses any key. If the user has not started typing (NO at 1012), the method 1000 continues to perform finger hovering detection above the anchor key area (1006). If the user has started typing by pressing any key on the virtual keyboard (YES at 1012), the visual hint(s) is dismissed (1014).

FIG. 10B is a method 1050 for facilitating user interactions with the virtual keyboard according to a fourth aspect of the first embodiment. In this aspect, a visual hint(s) will be triggered by detecting two or more user fingers resting/touching on the keyboard beyond a threshold period of time. In this aspect, when a user touches multiple fingers to the virtual keyboard, such as to search for the anchoring (i.e. F and J keys) to get the correct hand posture for typing (which is similar to how a user interacts with a physical keyboard), the virtual keyboard enters a finger resting mode or touch-typing mode. In this mode, to support the user finger positioning before any key is pressed, the virtual keyboard presents a visual hint(s) onto the anchoring (e.g. F and J keys) to guide the finger positions. After the user types, or the keyboard exits this mode, the hint(s) would be dismissed.

A user launches the virtual keyboard (1052), and the keyboard is idle for a certain timeframe (1054) (no typing event, no palm-resting or finger-hovering/touching event detected and Δt>threshold).

A determination is made if a visual hint display condition is met by performing finger touching/resting detection (1056). The finger resting detection comprises determining if two or more user fingers are resting on the virtual keyboard (without pressing of keys) for a threshold period of time. The finger resting detection may be performed for the entire virtual keyboard, or only a specific area of the virtual keyboard such as a home row, which comprises the anchoring keys.

If it is determined that the two or more user fingers are resting for a threshold period of time (YES at 1058), the visual hint display condition is satisfied and a visual hint(s) is displayed in association with one or more anchoring keys (e.g. the F and J keys) on the virtual keyboard (1060). If the visual hint display condition is not met (NO at 1058), the method 1050 returns to performing finger resting detection (1056).

After the visual hint is displayed, a determination of whether a visual hint dismissal condition is met is based on whether the user has typed on any key of the virtual keyboard (1062), such that the visual hint(s) will be dismissed after the user presses any key. If the user has not started typing (NO at 1052), the method 1050 continues to perform finger resting detection (1056). If the user has started typing by pressing any key on the virtual keyboard (YES at 1062), the visual hint(s) is dismissed (1064).

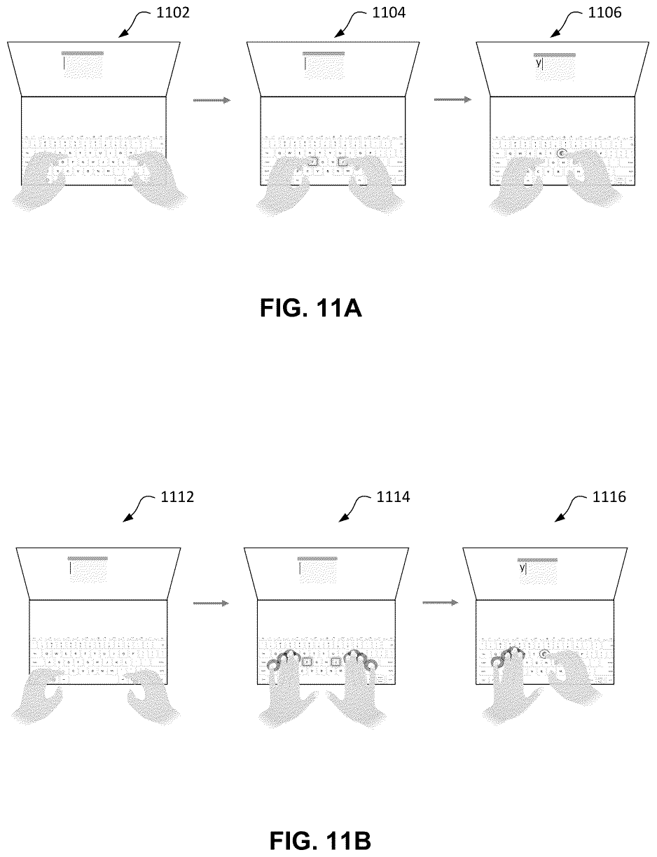

FIG. 11A is a representation of the user interactions with the virtual keyboard according to the third aspect of the first embodiment. As shown in FIG. 11A, the virtual keyboard is launched and in an idle mode, and the user's hands/fingers are far away from the anchoring (i.e. F and J) keys (1102). When the user finger(s) are hovering less than a threshold distance above the anchoring key area for a threshold period of time, a visual hint(s) is displayed on the anchoring keys (1104), which is shown as highlighting associated with these keys in this example. When the user has typed any key, the visual hint(s) is dismissed (1106).

FIG. 11B is a representation of the user interactions with the virtual keyboard according to the fourth aspect of the first embodiment. As shown in FIG. 11B, the virtual keyboard is launched and in an idle mode (1112). When two or more user fingers touch the virtual keyboard and rest on the keyboard for a threshold period of time, the virtual keyboard enters a finger resting mode and a visual hint(s) is displayed on the anchoring keys (1114), which is shown as highlighting associated with these keys in this example. When the user has typed any key, the visual hint(s) is dismissed (1116).

A second embodiment of the present disclosure focuses on presenting a visual hint(s) based on language model predictions. There are two aspects of the second embodiment contemplated for presenting a visual hint(s) based on language model prediction: (1) presenting a visual hint(s) for correcting spelling errors; and (2) presenting a visual hint(s) for predicted punctuation.

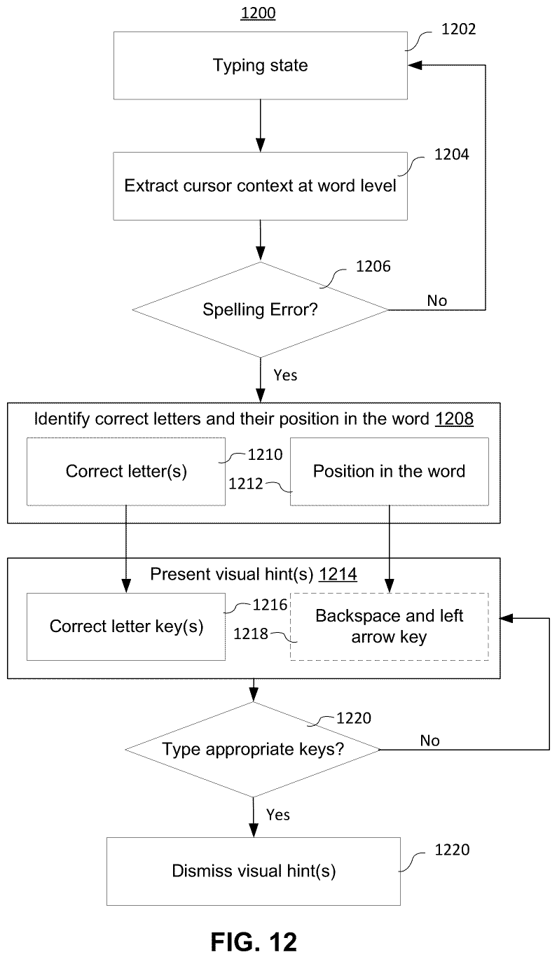

FIG. 12 is a method 1200 for facilitating user interactions with the virtual keyboard according to a first aspect of the second embodiment, i.e. presenting visual hint(s) for correcting spelling errors. In this aspect, upon the entry of an incorrect letter by the user, a corresponding visual hint(s) are displayed in association with a specific key(s), including but not limited to the Backspace, arrow keys, and/or correct letter keys. The visual hint(s) will disappear when correction behavior is completed. The virtual keyboard is in a typing state (1202) where a user is actively using the virtual keyboard to perform typing. During the user's typing, the system will continuously extract cursor context at both word and sentence level (1204).

A language model or trained AI model running backend can be used to detect any potential spelling errors. A determination is made as to whether there is a spelling error (1206), which is the visual hint display condition. If there is no spelling error (NO at 1206), the method returns to 1202. If a spelling error is detected (YES at 1206), the visual hint display condition is satisfied.

To determine where and how to display the visual hint(s), the method 1200 comprises identifying the correct letter(s) and their position in the word (1208). The correct letter(s) are determined (1210) that would correct the spelling error. Further, the position of the letter(s) in the word (for example, whether they are at the beginning of the word, in the middle of the word, or at the end of the word) is determined (1212).

Visual hint(s) are presented (1214) in association with one or more keys on the virtual keyboard for correcting the spelling error. For example, the visual hint(s) may be displayed in association with one or more keys corresponding to the correct letter(s) (1216). Additionally, a visual hint may be displayed in association with a backspace key. Depending on the position of the incorrect letter(s), a visual hint may be displayed in association with a left arrow key (for example if the incorrect letter appears before the last letter) (1218).

After the visual hint(s) is displayed, a determination of whether a visual hint dismissal condition is met is determined based on whether the user has typed the appropriate key(s) for correcting the spelling error (1220), i.e. the one or more keys associated with the visual hint. The determination of whether the visual hint dismissal condition is met may comprise determining that the user has typed a number of keys that is greater than or equal to the keys associated with the visual hint (thus confirming that the correction is complete). When the user has not typed the appropriate key(s) (NO at 1220), the method continues to present the appropriate visual hints (1214). When the user has pressed the appropriate keys (YES at 1220), the visual hint(s) is dismissed (1220).

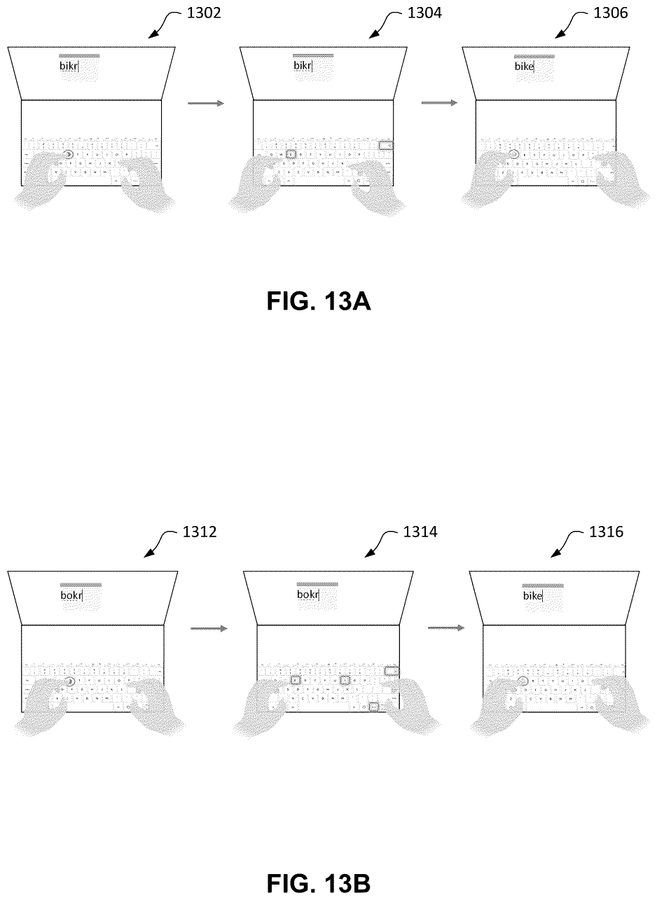

FIGS. 13A and 13B are representations of the user interactions with the virtual keyboard according to the first aspect of the second embodiment. FIG. 13A shows a representation of a last letter error, while FIG. 13B shows a representation of a middle letter(s) error.

As shown in FIGS. 13A and 13B, the user has pressed an incorrect letter (1302, 1312). A visual hint is displayed (1304, 1314) which is shown as highlighting associated with certain keys in this example. For the last letter error, visual hints are displayed in association with the correct letter key and the backspace key (1304). For the middle letter(s) error, visual hints are displayed in association with the correct letter keys, the backspace key, and the left arrow key (1314). When the user has typed the appropriate key(s) (e.g. the correct letter key, the backspace key, and optionally the left arrow key) and/or the number of keys pressed by the user is greater than or equal to the number of keys associated with the visual hint, the visual hints are dismissed (1306, 1316).

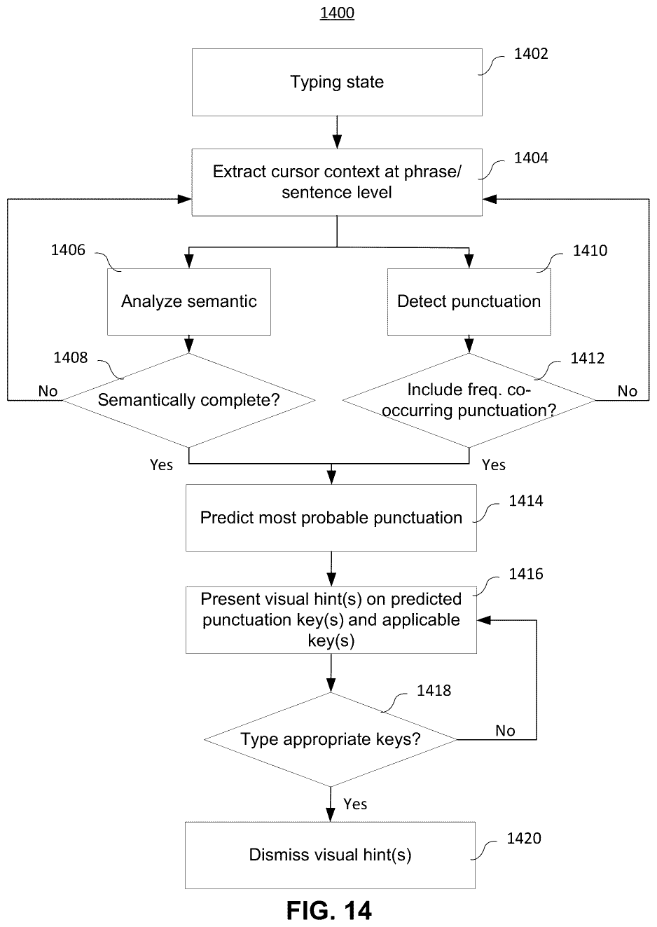

FIG. 14 is a method 1400 for facilitating user interactions with the virtual keyboard according to a second aspect of the second embodiment, i.e. presenting visual hints for predicted punctuation. In this embodiment, the system extracts the cursor context while the virtual keyboard is in a typing state.

A language model or trained AI model is running backend to perform both semantic analysis and punctuation detection and prediction concurrently. The two major categories of punctuation in prediction are: (1) punctuations used when a phrase or sentence is semantically completed, e.g.: , . ?!: ; and (2) frequently co-occurring or paired punctuations, e.g.: ‘ ’ 37” < > [ ] { }.

The virtual keyboard is in a typing state (1402) where a user is actively using the virtual keyboard to perform typing. During the user's typing, the system will continuously extract cursor context at both word and phrase/sentence level (1404).

A language model or trained AI model running backend can be used to analyze the semantic context (1406) and/or to detect punctuation in the sentence (1410). A determination is made as to whether the phrase/sentence is semantically complete (1408), and if so (YES at 1408), predicts the most probable punctuation (1414) that a user would type at the end of the sentence. If punctuation is detected, a determination of whether there is a frequently co-occurring punctuation (such as < > or ‘ ’) is determined (1412), and if so (YES at 1412), predicts the most probable punctuation (1414) that the user would type based on the frequently co-occurring punctuation. If it is determined that the phrase/sentence is not semantically complete (NO at 1408) or that there is no frequently co-occurring punctuation with the detected punctuation mark (NO at 1412), the method 1400 continues to extract cursor context (1404).

In the method 1400, the generation of predicted punctuation is a visual hint display condition, and accordingly, once punctuation has been predicted a visual hint(s) is displayed in association with one or more keys for the predicted punctuation (1416). For example, once the predicted punctuation is determined (such as a period “.”, “?” or “>”), a visual hint(s) will be displayed on the corresponding punctuation key, and optionally on other applicable keys such as the Shift key.

After the visual hint is displayed, a determination of whether a visual hint dismissal condition is met is determined based on whether the user has typed the appropriate key(s) associated with the visual hint(s) (1418). The determination of whether the visual hint dismissal condition is met may comprise determining that the user has typed a number of keys that is greater than or equal to the keys associated with the visual hint (thus confirming that the operation is complete). When the user has not typed the appropriate keys (NO at 1418), the method continues to present the appropriate visual hint(s) (1416). When the user has pressed the appropriate keys (YES at 418), the visual hint(s) is dismissed (1420).

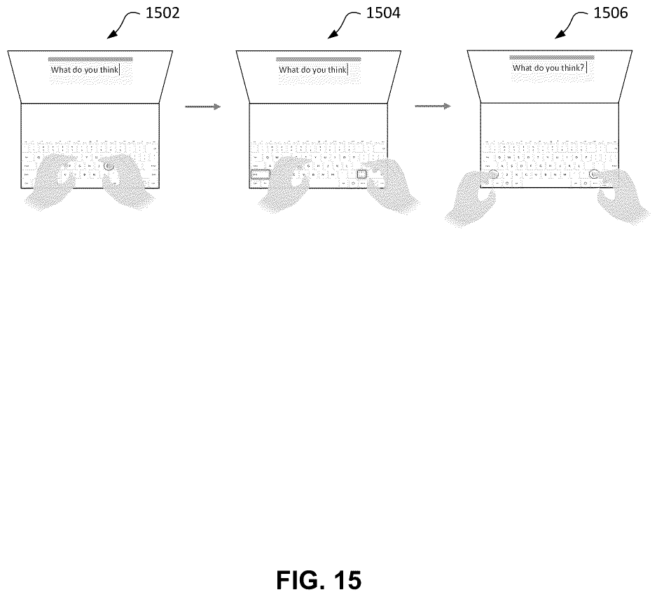

FIG. 15 is a representation of the user interactions with the virtual keyboard according to the second aspect of the second embodiment. In the example shown in FIG. 15, the user has typed a complete sentence with the exception of a punctuation mark (1502). A predicted punctuation mark is determined and a visual hint is displayed in association with one or more keys corresponding to the predicted punctuation mark, and optionally other keys for implementing the predicted punctuation mark such as the Shift key (1504), which is shown as highlighting associated with these keys in this example. When the user has typed the appropriate key(s) (e.g. the correct punctuation key) and/or the number of keys pressed by the user is greater than or equal to the number of keys associated with the visual hint(s), the visual hint(s) is dismissed (1506).

A third embodiment of the present disclosure focuses on writing tool interactions, and in particular to showing a visual hint(s) in response to writing suggestions generated by an editor application or other application. Writing suggestions may include text, words, phrases, numbers, punctuation, symbols, emojis, etc.). In this case, the editor application usually has a language model or AI model predicting the next word or phrases, and shows the prediction in a particular format, such as a greyed text, a list of words in a floating window, etc.

For example, inline completion suggestions may show greyed texts that are predicted and suggested text, and a user could tap the “Tab” key to accept the suggested text to complete the sentence.

An upper/lower floating window may present multiple predicted words. For an upper floating window, a user may tap the “up arrow” key to highlight the first suggested word in the floating window, and then press “right arrow” key to move the highlight to the second word, or press one more “right arrow” to highlight the third word. For a lower floating window, a user may tap the “down arrow” key to highlight the first suggested word in the floating window, and then press “down arrow” key again to move the highlight to the second word, or press one more “down arrow” to highlight the third word.

Finally, the user may type “Enter” key to accept the highlighted word.

Accordingly, a user can type particular functional keys, or key combinations (defined by the editor application) to interact with the writing suggestions. In this third embodiment, the virtual keyboard listens to the editor application about the writing suggestion statues and the next operation (such as a shortcut key or key combinations). When the writing suggestions in the editor are presented, and next operation information is obtained, a visual hint display condition is determined and the virtual keyboard displays a visual hint(s) associated with one or more applicable keys, such as arrow keys, Tab key, Enter key, etc. Once suggested word/texts are registered or updated, or the suggested operational keys are updated, the visual hint(s) are dismissed.

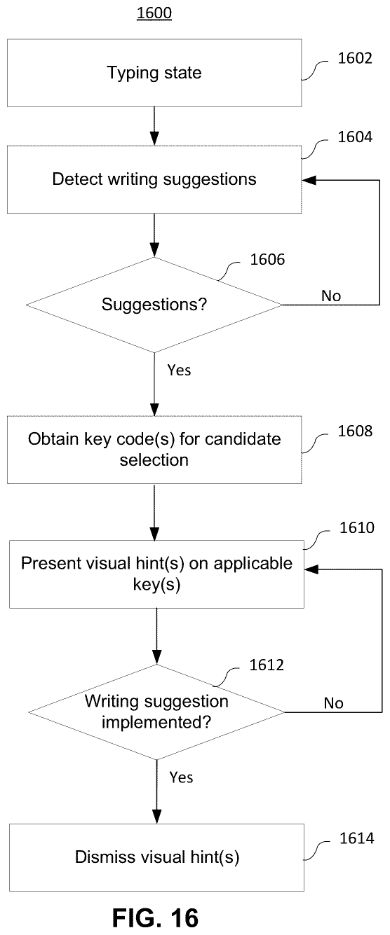

FIG. 16 is a method 1600 for facilitating user interactions with the virtual keyboard according to an aspect of the third embodiment.

The virtual keyboard is in a typing state (1602) where a user is actively using the virtual keyboard to perform typing within an editor application. During the typing state, the virtual keyboard is in communication with the editor application, and detects if there are writing suggestions generated by the editor application (1604). A determination is made if writing suggestions are detected (1606). In the method 1600, the writing suggestions provided by the editor application correspond to the visual hint display condition. If it is determined that there are writing suggestions (Yes at 1606), a key code for the candidate selection (e.g. shortcut key or key combinations to select a candidate) are determined/obtained (1608), and a visual hint(s) is displayed in association with one or more of the keys for implementing the writing suggestion (1610). If there are no writing suggestions (No at 1606), the method 1600 continues to detect writing suggestions (1604) from the editor application.

After the visual hint(s) is displayed, a determination of whether a visual hint dismissal condition is met is determined based on whether the writing suggestion has been implemented (1612). For example, the virtual keyboard in communication with the editor application can determine that the suggested word/texts are registered or updated, or that the suggested operational keys are updated. When the writing suggestions have not been implemented and/or the suggested operational keys have not been updated (No at 1612), the method continues to present the appropriate visual hint(s) (1610). When the writing suggestions have been implemented (Yes at 1612), the visual hint(s) is dismissed (1614).

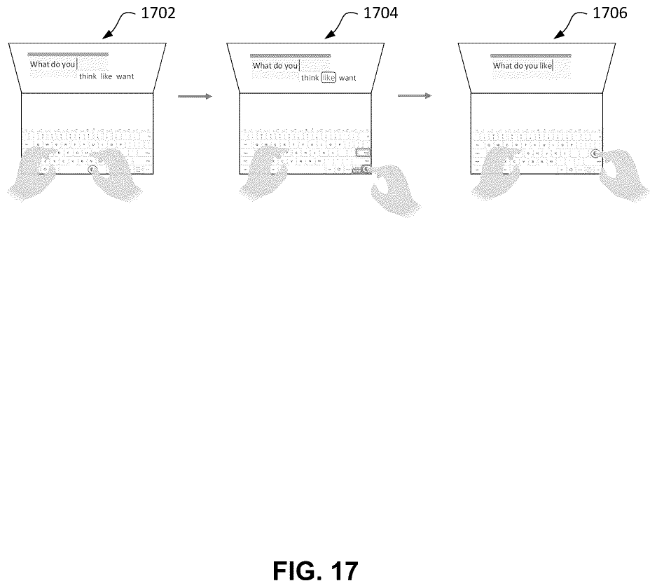

FIG. 17 is a representation of the user interactions with the virtual keyboard according to the aspect of the third embodiment. As shown in FIG. 17, the user is typing in the editor interface and suggested words appear in a floating window (1702). A visual hint(s) is displayed in association with one or more key(s) on the virtual keyboard for selecting a suggested word (1704), which is shown as highlighting associated with certain keys in this example. A corresponding visual hint may also be presented in the editor interface to highlight a current word selection based on the user's interactions with the keys on the virtual keyboard. Once a user has selected a suggested text, the visual hints are dismissed (1706).

A fourth embodiment of the present disclosure is similar to the third embodiment in that it relates to writing suggestions, however this embodiment covers a scenario where the editor application does not have its own writing suggestion mechanism. In this embodiment, the virtual keyboard system determines the writing suggestions and communicates the writing suggestions to the editor application for presentation on the editor interface. The writing suggestions determined by the virtual keyboard according to this embodiment may comprise generating predicted text for next word/phrase/sentence (for completion), and/or may comprise predicting the correct word if the typed word has a spelling error (for correction).

In this embodiment, the keyboard system extracts the cursor context while the keyboard is in typing state. A language model or trained AI model is running backend to perform functionality including but not limited to: semantic analysis, word/sentence prediction, error detection, and/or punctuation detection/prediction, etc., each of which may be performed concurrently. When a writing prediction is generated, the suggested texts (e.g. a next word/phrase/sentence, a corrected word, etc.) are presented onto the editor interface using a distinct visual format compared to regular text, such as in greyed text or showing a flowing window of suggested word or list of words. At the same time, if applicable, the key or key combinations for an operation to implement the writing suggestion are highlighted on the keyboard (for example using a similar method as in the third embodiment described above). Once suggested word/texts are registered or updated, the system dismisses all the visual hints.

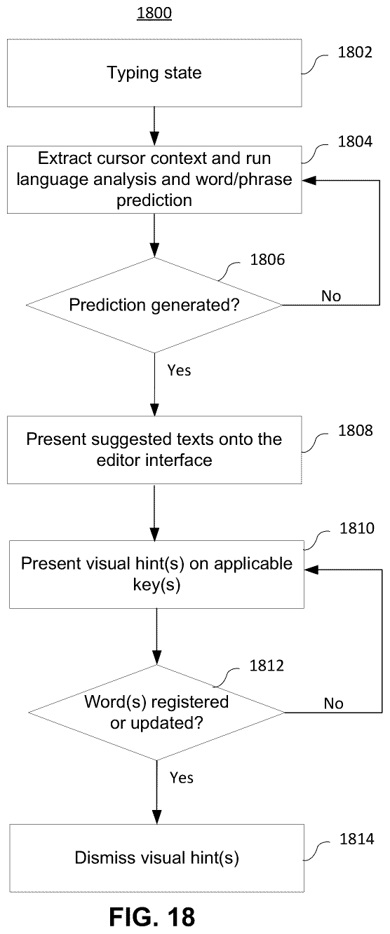

FIG. 18 is a method 1800 for facilitating user interactions with the virtual keyboard according to an aspect of the fourth embodiment.

The virtual keyboard is in a typing state (1802) where a user is actively using the virtual keyboard to perform typing within an editor application. During the typing, the virtual keyboard system extracts the cursor context and runs a language model and/or a word/phrase prediction model to generate predicted text (1804). As described above, a predicted text my comprise a next word/phrase/sentence, a corrected word when a spelling error is detected, etc. A determination is made if a prediction has been generated (1806). In the method 1800, the generation of predicted text corresponds to the visual hint display condition. If it is determined that there is predicted text (Yes at 1806), the suggested text is presented onto the editor interface (1808), and a visual hint(s) is displayed in association with one or more of the keys for implementing the predicted text (1810). If there is no predicted text (No at 1806), the method 1800 continues to extract cursor context and generate predicted text (1804).

After the visual hint(s) is displayed, a determination of whether a visual hint dismissal condition is met is determined based on whether the predicted text (i.e. the writing suggestion) has been implemented (1812). When the writing suggestion(s) has not been implemented (No at 1812), the method continues to present the appropriate visual hint(s) (1810). When the writing suggestions have been implemented (Yes at 1812), the visual hint(s) is dismissed (1814).

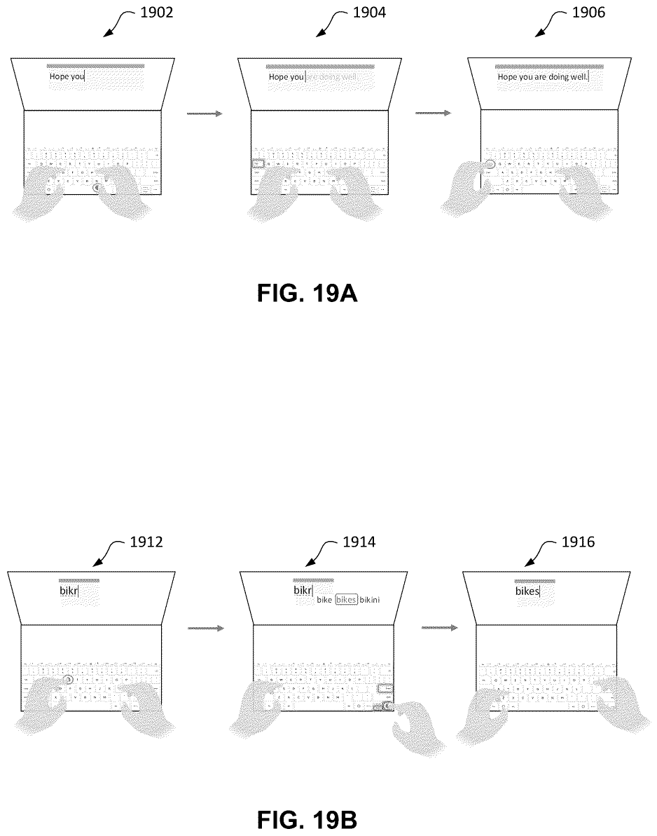

FIGS. 19A and 19B are representations of the user interactions with the virtual keyboard according to the aspect of the fourth embodiment.

FIG. 19A shows an example of predicted text for sentence completion. In the example shown in FIG. 19A, after a user has typed “Hope you” (1902), the keyboard system predicts the following text as “are doing well.” The predicted texts are considered as suggested text and are presented as visual hints on the editor interface in greyed text following the current cursor position; further, a Tab key may be used to accept the suggested text, and a visual hint associated with the Tab key on the virtual keyboard may be highlighted (1904). After the user types the Tab key, the suggested text is registered, and all visual hints are dismissed (1906).

FIG. 19B shows an example of predicted text for correcting errors. In the example shown in FIG. 19B, the user has incorrectly typed “bikr” (1912). The keyboard system determines that the text contains an error and predicts several correct words, which are presented in a floating window in the editor interface; further, a Tab key for accepting the corrected text and/or an arrow key to facilitate navigating between the suggested words may be highlighted to provide a visual hint to the user (1914). After the user navigates to the correct word and types the Tab key, the suggested text is registered, and all visual hints are dismissed (1916).

It will be appreciated that while the visual hints shown in the fourth embodiment look similar to those presented in the third embodiment, a fundamental difference is that the suggested texts on the editor interface is generated by the editor application in the third embodiment, while the suggested texts in the fourth embodiment are generated by the keyboard system.

A fifth embodiment of the present disclosure focuses on presenting visual hints for selecting characters/symbols when typing in various languages. For example, when a user is typing Pinyin using a Chinese input method, Chinese character or word candidates are shown in a floating window adjacent to the cursor. Usually, tapping the space bar will register the first candidate, however, if the desired candidate is not the first candidate, the user needs to type the corresponding number to choose the desired candidate. A key difference between writing suggestions shown in an editor application and input-method generated character/symbol candidates using a Chinese input method is that with an editor application, a user can ignore those suggestions as any interaction with the suggestions is not a prerequisite step for typing. However, in Chinese typing, the input method is an interface between keyboard and editor, a user has to make a response (e.g. press the spacebar to pick the first one, or choose a number to pick the corresponding candidate) so that the characters can be registered to the editor. Accordingly, picking a character/symbol candidate is a required step in this embodiment.

The fifth embodiment focuses on guiding a user to choose a character/symbol candidate using a language input method such as a Chinese input method without checking the number keys. In this embodiment, when a floating window is shown in Chinese typing, the virtual keyboard system performs finger hover event detection on the row of number keys. The finger hover detection by the virtual keyboard system may be constantly on, or it may be turned on when the floating window appears in the input method interface. With this type of input method, the user reaches their finger to the number row and hovers their finger on top a particular number key. Once the finger hovering time is longer than the time threshold and/or the hovering distance is less than the distance threshold, a finger hover event is detected, and the system identifies the specific number key underneath the hovering finger. The visual hints can be presented to highlight the corresponding candidate in the floating window of the Chinese input method that is associated with the number key, and optionally presented on the number key of the keyboard as well. If the user moves the hovering finger to a different number key, the visual hints should be updated accordingly and highlight the current number key beneath the hovering finger and corresponding candidate. To achieve this effect, the keyboard is in communication with the input method (an application typically provided by a third party) via API communication and the input method listens to the keyboard to update the states accordingly.

Alternatively, the keyboard may be a module of the input method application. Once the user finally chooses a candidate word by pressing a number key (or pressing another key such as the Spacebar), the system dismisses the visual hint(s), and may stop performing finger hovering detection.

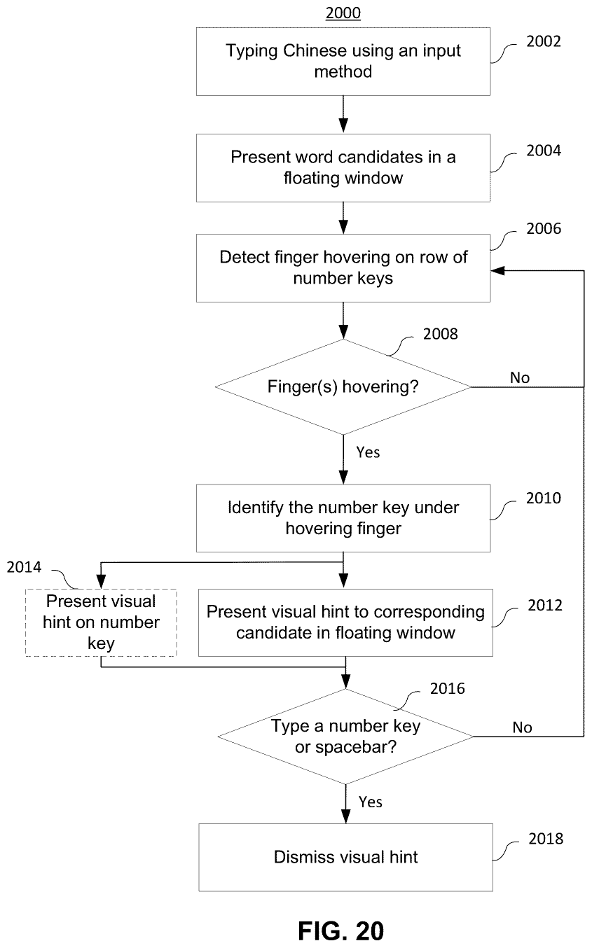

FIG. 20 is a method 2000 for facilitating user interactions with the virtual keyboard according to an aspect of the fifth embodiment.

A user types Pinyin using a Chinese input method (2002), and the Chinese input method presents Chinese character or word candidates in a floating window (2004). The virtual keyboard system detects finger hovering above the row of number keys that is used to select a corresponding Chinese character (2006). A determination is made as to whether a user finger was detected hovering a distance less than a threshold above the row of number keys for a threshold period of time (2008), which corresponds to the visual hint display condition. If there is no finger hovering detected (No at 2008), the method continues to detect finger hovering (2006). If finger hovering is detected (Yes at 2008), a number key underneath the hovering finger is identified (2010).

A visual hint(s) is presented in the Chinese input method application in association with the Chinese character candidate corresponding to the identified number key (2012). Optionally, a visual hint may also be displayed on the virtual keyboard in association with the identified number key (2014).

After the visual hint is displayed, a determination of whether a visual hint dismissal condition is met is determined based on whether the user has pressed the number key or has pressed another key to select the Chinese character candidate (2016). If the user has not pressed the relevant key(s) (No at 2016), the method returns to detecting finger hovering (2006). If the user has pressed the relevant key(s) (Yes at 2016), the visual hint(s) is dismissed (2018).

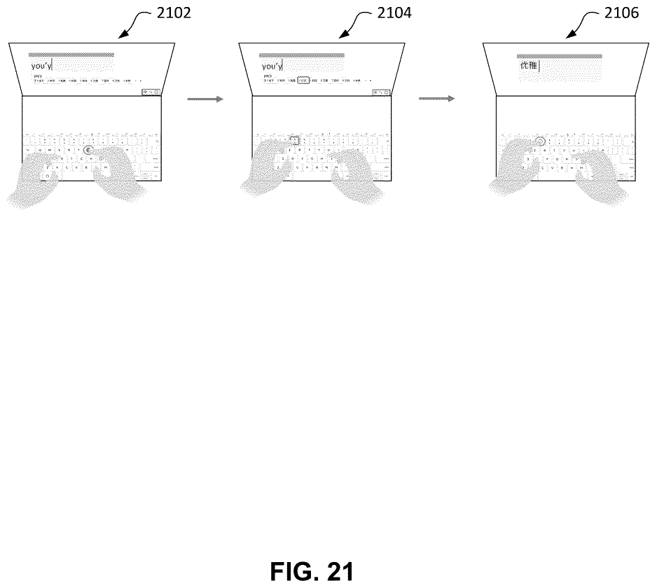

FIG. 21 is a representation of the user interactions with the virtual keyboard according to the aspect of the fifth embodiment. As shown in FIG. 21, the user begins typing Pinyin using a Chinese input method (2102). A floating window appears showing Chinese character or word candidates; when a user finger hover event is detected over a number key, a visual hint(s) is displayed in association with the corresponding candidate selection and/or the number key (2104). When the user has pressed the relevant key, the Chinese character or word is selected, and the visual hint(s) is dismissed (2106).

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method comprising:
receiving contextual information associated with a virtual keyboard displayed on a user interface;
determining, based on the contextual information, that a visual hint display condition is met;
displaying a visual hint associated with one or more keys of the virtual keyboard based on the visual hint display condition;
after displaying the visual hint, receiving additional contextual information associated with the virtual keyboard;
determining, based on the additional contextual information, that a visual hint dismissal condition is met; and
dismissing the visual hint from the virtual keyboard based on the visual hint dismissal condition.

2. The computerized method of claim 1, wherein determining that the visual hint dismissal condition is met comprises determining that the visual hint display condition is no longer met, and dismissing the visual hint from the virtual keyboard when the visual hint display condition is no longer met.

3. The computerized method of claim 1, wherein the contextual information comprises one or more of: a user's finger and/or palm position with respect to the virtual keyboard, one or more keys pressed by the user on the virtual keyboard, word and/or sentence context written by the user of the virtual keyboard, writing suggestions, and input-method generated character/symbol candidate suggestions.

4. The computerized method of claim 1, wherein the visual hint display condition is one of:
one or both user palms are resting in a region below the virtual keyboard in a pre-typing state for a first threshold period of time;
one or more user fingers are hovering less than a threshold distance above the virtual keyboard for a second threshold period of time;
the virtual keyboard is in an idle state for a third threshold period of time;
one or more user fingers are hovering less than the threshold distance above an anchoring key area of the virtual keyboard for a fourth threshold period of time; and
two or more user fingers are resting on the virtual keyboard for a fifth threshold period of time.

5. The computerized method of claim 4, wherein the visual hint that is displayed is associated with anchoring keys on the virtual keyboard.

6. The computerized method of claim 5, wherein the visual hint dismissal condition is that a user has pressed any key on the virtual keyboard.

7. The computerized method of claim 1, wherein the visual hint display condition is a spelling error.

8. The computerized method of claim 7, wherein the visual hint that is displayed is associated with one or more keys for correcting the spelling error, and the visual hint dismissal condition is that a user has pressed the one or more keys associated with the visual hint.

9. Ther computerized method of claim 1, wherein the visual hint display condition is a predicted punctuation.

10. The computerized method of claim 9, wherein the visual hint that is displayed is associated with one or more keys for the predicted punctuation, and the visual hint dismissal condition is that a user has pressed the one or more keys associated with the predicted punctuation.

11. The computerized method of claim 1, wherein the visual hint display condition is one of:
a writing suggestion provided by an application; and
a writing suggestion provided by the virtual keyboard.

12. The computerized method of claim 11, wherein the visual hint that is displayed is associated with one or more keys for implementing the writing suggestion.

13. The computerized method of claim 12, wherein the visual hint dismissal condition is that the writing suggestion has been implemented.

14. The computerized method of claim 1, wherein the visual hint display condition is one or more user fingers hovering less than a threshold distance over a key on the virtual keyboard corresponding to an input-method generated character/symbol suggestion for a threshold period of time.

15. The computerized method of claim 14, wherein the visual hint that is displayed is associated with the key that the one or more user finger is hovering over, and/or the input-method generated character/symbol suggestion corresponding to the key.

16. The computerized method of claim 15, wherein the visual hint dismissal condition is that the user has chosen the suggested symbol by pressing the corresponding key on the virtual keyboard.

17. The computerized method of claim 1, wherein displaying the visual hint associated with the one or more keys of the virtual keyboard comprises highlighting the one or more keys of the virtual keyboard.

18. The computerized method of claim 1, wherein displaying the visual hint associated with the one or more keys comprises dynamically displaying the visual hint.

19. The computerized method of claim 1, wherein displaying the visual hint associated with the one or more keys of the virtual keyboard comprises highlighting a selection on the user interface that corresponds to the one or more keys of the virtual keyboard.

20. One or more processors functionally connected to one or more memories storing instructions, the one or more processors configured to execute the instructions to perform a computerized method comprising:
receiving contextual information associated with a virtual keyboard displayed on a user interface;
determining, based on the contextual information, that a visual hint display condition is met;
displaying a visual hint associated with one or more keys of the virtual keyboard based on the visual hint display condition;
after displaying the visual hint, receiving additional contextual information associated with the virtual keyboard;
determining, based on the additional contextual information, that a visual hint dismissal condition is met; and
dismissing the visual hint from the virtual keyboard based on the visual hint dismissal condition.
